(19) United States
(12) Patent Application Publication
(10) Pub. No.: US 2008/0124527 A1
(43) Pub. Date: May 29, 2008

(54) Envelopment of Components Arranged on a Substrate

(75) Inventors: Ladislaus Bittmann, Munchen (DE); Karl Weidner, Munchen (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/791,687

(22) PCT Filed: Sep. 7, 2005
(86) PCT No.: PCT/EP05/54409

§ 371 Date: May 25, 2007

(30) Foreign Application Priority Data
Nov. 29, 2004 (DE) 10 2004 057 493.6

(51) Int. Cl. B32B 3/02; B32B 37/10

(52) U.S. Cl. 428/201; 156/213

(57) ABSTRACT

A method for enveloping components arranged on a substrate, with a film which is made of an electrically insulating plastic material, and the substrate. The film is placed on the components to be enveloped on the side thereof facing away from the substrate. Elastically or plastically deformable impression material is placed onto the film on the side thereof which faces away from the components to be enveloped. The impression material is pressed against the film in the direction of the components and the substrate and the impression material is removed.

The invention relates to a method for enveloping a three-dimensional structure, in particular components arranged on a substrate, by means of a film which is made of an electrically insulating plastic material and the substrate.

Suitable polymer films which are planar pressed are used in a conventional manner. The flow characteristics of the material allow adjustments to be made to the component topography.

This type of envelopment is nevertheless disadvantageous in that the adjustment of the film to the component topography is simply inadequate. The inadequate provision of a homogenous layer thickness of the film envelopment around the components is a problem. Miniaturizations of the layer thicknesses can occur particularly on corners and edges of the components, thereby in particular reducing the insulation characteristic of the film. Voltages sparkovers are minimized in this manner. Adequate insulation can thus not always be guaranteed. In addition, the film preferably flows downwards on the sides in the direction of the force of gravity, with little film material contrastingly collecting thereabove. Only a reduced insulation with reduced voltage sparkovers is thus also produced on the upper component regions. If a planar pressing is also carried out, particularly by means of rollers, horizontal forces and thus also further film material displacements likewise occur and error adjustments resulting therefrom. The flow behavior of the film is also dependent on the environment, in particular on temperature, pressure and air humidity, so that controlling the process outside the reaction chamber becomes increasingly more difficult.

The object of the invention is thus to provide as exact an application of an (impression) film made of electrically insulating plastic material on a surface topography as possible, in particular on components arranged on a substrate. In order to envelope components arranged on a substrate by means of a film made of electrically insulating plastic material and the substrate, a method which is advantageous compared with the conventional method and a device resulting therefrom are to be created. Insulation films are to be pressed in precisely three-dimensional manner by means of a lamination process. This relates in particular to component arrangements having a strong topography. Furthermore, film materials are to be conserved.

The object is achieved by a method according to the main claim and a device according to the subordinate claim. Further advantageous embodiments emerge from the subclaims.

By pressing an elastically or plastically deformable impression material against the film in the direction of the components and the substrate, the film is also pressed against the surfaces of the components and of the substrate. In this way, the impression material not only presses vertically downwards onto the corresponding surfaces of the substrate and the components but likewise horizontally onto the side surfaces of the component in the spaces between the components. A constant layer thickness of the film, in particular on corners and edges of the components is generated in this manner. The impression material optimally adjusts itself to the surface topography. Topography is understood to mean the structuring of a surface. The impression material can also be a sandwich structure having different functions.

The generation of an image of a structured surface having a surface profile and/or surface topography is understood to mean impressing by means of an impression material. An impression (in particular pressing) of the surface topography is thus carried out, with a negative mold generated by the molded impression material being generated for surface topography. This negative mold is used for an impression for developing a precise film/insulation film with high-precision adjustment to the surface topography.

By using a plastically or elastically deformable impression material, an impression or mapping of the topography of a surface of a component/substrate structure is carried out on a film made of electrically insulating plastic material. The film is adjusted precisely to the topography and has a homogenous thickness.

If the impression material is plastically deformable, this can be used again in the original state after the pressing process and after a deformation. In the case of an elastically deformable impression material, this can be used again without any further intermediate steps after the pressing process has finished.

According to an advantageous embodiment, the impression material is pressed against the film from the side of the impression material facing away from said film. The pressing is herewith carried out mechanically. By way of example, a layer stack in the form of a press packet is used for pressing purposes. The process can be generated hydraulically. A mechanical pressing can be provided in an autoclave.

According to a further advantageous embodiment, the impression material is pressed against the film from the side of the impression material facing away from the film by means of a pressurized gas. The gas preferably functions in an isostatic manner. Nitrogen or air are particularly suitable as gases. The pressure is generated in particular in a reaction chamber, e.g. in an autoclave.

According to a further advantageous embodiment, the impression material is pressed against the film by means of a vacuum provided on the side of the substrate facing away from the components and taking effect through the substrate via channels. The process is also carried out here in a reaction chamber. The vacuum pressing (or suction) can supplement a mechanical pressing or a pressing by means of gas. The latter case allows the use of impression films as impression materials.

According to a further embodiment, the film is fastened to the components and the substrate by means of a vacuum provided on the side of the substrate facing away from the components and taking effect via channels, in particular channels through the substrate or through a supporting table. This fastening prevents air bubbles from forming between the film and the component and between the film and the substrate. The fastening can also be provided with gas for mechanical pressing and pressing purposes.

According to a further advantageous embodiment, a desired temperature and/or a desired humidity can be generated for the film by means of the impression material and/or through the impression material. The film can herewith cross-link and subsequently harden. An embrittlement or change in the characteristics of the film is prevented.

According to a further advantageous embodiment, the impression material is provided as an impression film. This applies in particular for the case in which a pressing is carried out by means of gas and by means of vacuum.

According to a further advantageous embodiment, the impression material is a polymer mass, a gel, a high temperature gel, an oil-filled (plastic) cushion, a silicon cushion, a laminator impression material or a rubber.

A gel is a finely dispersed (finely distributed) system made of (at least) a solid and liquid phase (a solid and a liquid material), which permeate one another and form a three-dimensional system. The viscosity lies between a liquid and a solid. A gel is thus neither really liquid (e.g. water), but also not really solid (e.g. a stone). Gel can be used as a carrier agent. Natural fats are also likewise often gels. Agars, guar gum or natrium alginate are used as gel creators. Gel is soft material.

The term rubber includes caoutchouc or gum.

According to a further advantageous embodiment, a separation film and/or protective film is formed between the impression material/impression film. The impression material/film can be easily removed after pressing. Adhesives are avoided.

According to a further advantageous embodiment, the impression is carried out in gas/vacuum presses and/or hydraulic vacuum presses and/or in autoclaves.

According to an advantageous embodiment, a device having components arranged on a substrate is generated, with the components on the substrate forming a strong surface topography and being enveloped by means of a film made of electrically insulating plastic material and the substrate. The film is designed with a constant thickness and is adjusted precisely to the surface topography. A minimal layer thickness of the film is provided in order to avoid voltage sparkovers.

As advantages, the present invention features a precise impression, uniform layer thicknesses, bubble-free impression, improved adhesive strength, improved cracking resistance, in particular in the edge region (with chip corners for instance) and the possibility of controlling radii. Components are advantageously enveloped, covered, encapsulated and surrounded.

The present invention is described in more detail below with reference to exemplary embodiments relating to the figures, in which;

FIG. 1 shows an exemplary embodiment at the start of an inventive method,

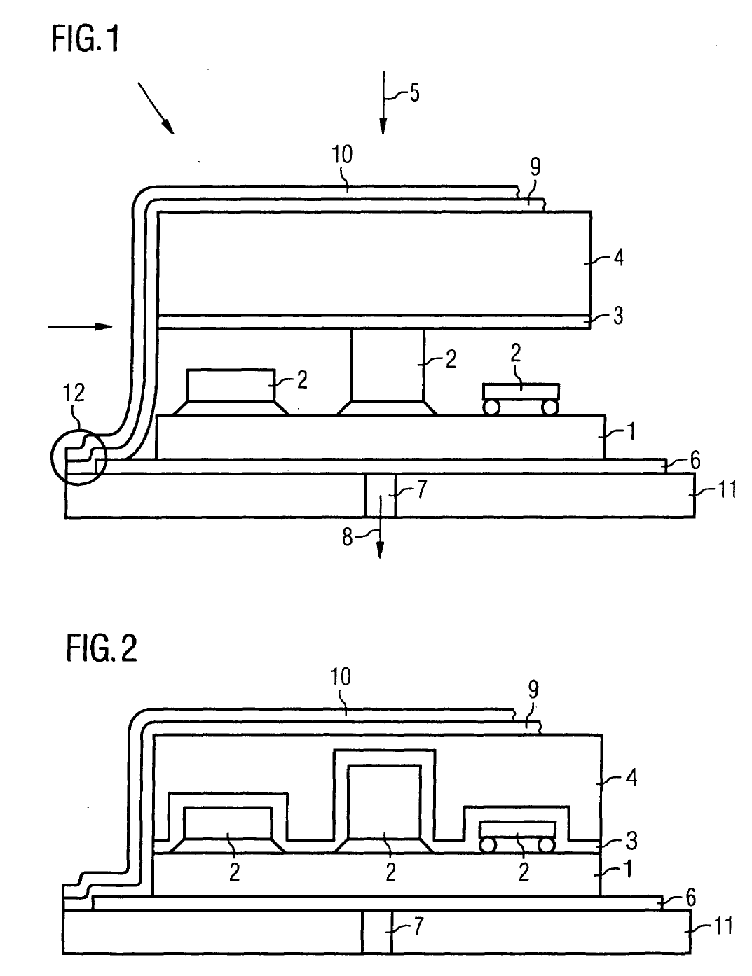

FIG. 2 shows an exemplary embodiment at the end of an inventive method,

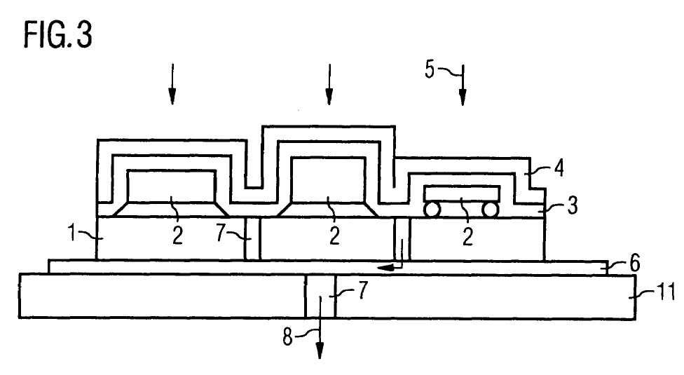

FIG. 3 shows a further exemplary embodiment according to the present invention.

FIG. 1 shows a design at the start of an exemplary embodiment of an inventive method prior to lamination. Components 2 are positioned on a substrate 1. An insulation film 3 is arranged over the components 2, said insulation film being horizontal and flat and resting on the highest component 2. Furthermore, an impression material 4 is arranged on the insulating film 3. A vacuum cover film 10 is arranged close to the impression material 4. A fleece 9 is provided between the vacuum cover film 10 and the impression material 4, said fleece being used to avoid cracks in the vacuum cover film 10 during the “pressing” step and/or pressing the method according to the invention. The substrate 1 is positioned on a table 11, with a temperature-stable grid system film 6 being established between the substrate 1 and the table 11. The grid system film 6 allows a vacuum 8 through channels 7 in the table 11 to have an effect on the insulation film 3 such that the film 32 is sucked-in in the direction of the components 2 and the substrate. In this way, air bubbles between the insulation film 3 and the substrate 1 are avoided in particular. In addition, a pressurized gas 5, which is for instance nitrogen or air, with comparable gases likewise being useable, acts on the vacuum cover film 10 in the direction of the components 2 and the substrate 1, so that the insulation film 3 is also pressed in this manner by means of the impression material 4 in the component topography. The vacuum cover film 10 is closely connected to the table 11 by means of an adhesive 12 so that the vacuum 8 can take effect and a lamination is enabled. A loss of the vacuum is herewith prevented. Comparable layer sequences for the lamination process are likewise possible.

FIG. 2 shows a device according to an exemplary embodiment at the end of the method according to an exemplary embodiment. The figure shows the substrate 1 which is equipped with the components 2. The insulation film 3, which was pressed by the impression material 4 in the direction of the components 2 and the substrate 1 is located over the surface structure. As an alternative to the pressurized gas 5, a mechanical press, in particular in the form of a press packet, could have taken effect above the impression material 4. A protective film can also be arranged below the substrate. The substrate strength can be in the range of 20 μm to 5 mm. The insulation film and/or film 3 can be in the range of 10 μm to 500 μm and thereabove. A component 2 can be 10 μm to above 5 mm high. A distance between two components 2 can amount to more than 20 μm for instance. The thickness of the impression material 4 can be greater than 1 mm for instance. Cu layers can be generated on the substrate 1 below the components 2.

The vacuum 8 below the substrate 1 can be generated both to fasten the film 3 to the components 2 and to the substrate 1 and also to pull the film 3 for pressing purposes. Channels 7 through the substrate 1 can likewise be provided. The use of a conventional autoclave is particularly advantageous.

FIG. 3 shows the arrangement according to the previous exemplary embodiment with the difference that the impression material 4 is designed as an impression film 4. The pressing is carried out from above by means of a pressurized gas 5. A vacuum 8 functions across the channels 7 from below the substrate 1 such that the impression film 4 also presses against the film 3 in the direction of the components 2 and the substrate 1. The vacuum can produce a pressure difference of up to approximately 1 bar for instance. It is particularly advantageous if the impression film 4 is somewhat harder than the insulation film 3, since a more precise molding of the insulation film 3 is herewith enabled. The softer insulation film 3 is herewith pressed and molded by the harder impression film 4 in a simpler manner. The insulation film 3 is created as a whole as an adhesive mass, which is then cross-linked and hardened. Alternatively or cumulatively the insulation film 3 can comprise additional adhesive layers.

FIGS. 2 and 3 show the end of the method step involving pressing the impression material 4 against the film 3 in the direction of the components 2 and in the direction of the substrate 1.

While further processing a device according to an exemplary embodiment, the envelopment can be provided with holes. A feed through to components 2 and to the printed circuit boards on the substrate 1 is then possible in these holes.

1-11. (canceled)

12. A method for enveloping components disposed on a substrate by way of a film and the substrate, the method which comprises the following steps:
placing a film of electrically insulating plastic material on the components to be enveloped, on a side thereof facing away from the substrate;
applying elastically or plastically deformable impression material to the film, on the side thereof facing away from the components to be enveloped;
pressing the impression material against the film in the direction toward the components and the substrate; and
removing the impression material.

13. The method according to claim 12, which comprises pressing the impression material against the film from the side of the impression material facing away from the film by way of a mechanical press.

14. The method according to claim 13, which comprises pressing the impression material with a press packet.

15. The method according to claim 12, which comprises pressing the impression material against the film from the side of the impression material facing away from the film by way of pressurized gas.

16. The method according to claim 12, which comprises pressing the impression material against the film by way of a vacuum provided on a side of the substrate facing away from the components and taking effect via channels formed through the substrate.

17. The method according to claim 12, which comprises fastening the film onto the components and the substrate by way of a vacuum provided on a side of the substrate facing away from the components and taking effect via channels formed through the substrate.

18. The method according to claim 12, which comprises supplying heat and/or humidity to the film by way of the impression material.

19. The method according to claim 12, which comprises heating and/or humidifying the film through the impression material.

20. The method according to claim 12, wherein the impression material is an impression film.

21. The method according to claim 12, wherein the impression material is a deformable material selected from the group consisting of a polymer mass, a gel, a high temperature gel, an oil-filled cushion, a silicon cushion, a laminated impression material, and a rubber.

22. The method according to claim 12, which comprises placing a separation film between the impression material and the film.

23. The method according to claim 12, which comprises placing a protective film between the impression material and the film.

24. The method according to claim 12, which comprises carrying out the pressing step in a gas vacuum press, a hydraulic vacuum press, and/or an autoclave.

25. An assembly, comprising:
a substrate;
a plurality of components disposed on said substrate and defining a surface topography above said substrate; and
a film of electrically insulating plastic material disposed on said components with a substantially constant thickness and precisely following the surface topography;
said film and said substrate together forming a complete envelope for said components.
